(19) United States
(12) Patent Application Publication
(10) Pub. No.: US 2002/0104009 A1
(43) Pub. Date: Aug. 1, 2002

(54) Portable computer that can be plugged into a backplane

(76) Inventor: Richard Zodnik, San Juan Capistrano, CA (US)

Correspondence Address: Ben J. Yorks, IRELL & MANELLA, LLP, Suite 400, 840 Newport Center Drive, Newport Beach, CA, 92660, US

(21) Appl. No.: 09/772,344

(22) Filed: Jan. 29, 2001

(51) Int. Cl. G06F 11/30

(52) U.S. Cl. 713/200

(57) ABSTRACT

A computer that can be plugged into a backplane which is coupled to a network. The backplane has a backplane identification that is retrieved by the computer and compared with a stored backplane identification. The stored backplane identification is the ID of the last backplane that was coupled to the computer. If the stored ID does not match the ID from the backplane, the computer transmits a command to the network indicating that the computer has been moved to a new physical location. A server can receive the command and automatically reconfigure the network so that a network address and/or telephone number associated with the computer is routed to the backplane. The computer may also transmit a client identification that is used by the server to determine whether the computer is authorized for usage.

### BACKGROUND OF THE INVENTION

1. Field of the Invention

The present invention relates to a portable computer that can be plugged into a backplane and coupled to a network.

2. Background Information

Most commercial offices are configured to allow a plurality of computers to be connected to one or more servers in a network. The network may include a local area network (LAN) and/or a wide area network (WAN). The computers are typically linked to the network through a data port that is physically connected to a number of routing wires. Each computer has an associated network address. Each data port has an associated physical address. The network will typically have a router(s) and hub that route information directed to the network addresses of the computers to the appropriate physical addresses of the data ports.

Some computers also have modem boards that are connected to voice ports of a telephone network. Each voice port has a unique phone number to allow routing of incoming information transmitted through the phone network. The telephone network will typically have switches to route phone calls to the appropriate voice ports.

The server of the network may have a software program that allows an operator to correlate the network address of the computer with the physical address of the data port. This correlation allows the network router and hub to route information to the appropriate computer. Likewise, the switch(es) of the telephone network may have a software program that allows an operator to correlate a phone number with a particular a physical cable number associated with the voice port.

Commercial entities will periodically move employees to different office locations. This typically requires moving the employee's computer. Each time a computer is moved to a different location an operator must re-configure the server and/or phone switches to correlate the computer with the new data and voice port locations. Re-configuring the network is time consuming and adds to the cost of moving the employees. Additionally, the employee is unable to move the computer without seeking the assistance of an operator to re-configure the network. This limits the mobility of the employee and their computer. It would be desirable to provide a system and method that allows an end user to plug a computer into a network and have the network automatically re-configured without any operator assistance.

### BRIEF SUMMARY OF THE INVENTION

In one embodiment the present invention includes a computer that can be plugged into a backplane. The backplane contains a unique backplane identification that is compared by the computer with a stored backplane identification. The computer can transmit a command to reconfigure a network if the stored backplane identification does not match the backplane identification of the backplane.

### BRIEF DESCRIPTION OF THE DRAWINGS

FIG. 1 is an illustration showing an embodiment of a computer and a backplane of the present invention.;

FIG. 2 is a schematic of a system that includes the computer and the backplane;

FIG. 3 is a diagram showing a relational database stored by a server of the system;

FIG. 4 is a flowchart showing an operation of the system;

FIG. 5 is a diagram showing an alternate embodiment wherein the system includes a server that is coupled to a phone switch by a network connection;

FIG. 6 is an illustration showing an alternate embodiment of a backplane that can be coupled to a computer.

### DETAILED DESCRIPTION OF THE PREFERRED EMBODIMENT

In general the present invention includes a computer that can be plugged into a backplane which is coupled to a network. The backplane has a backplane identification that is retrieved by the computer and compared with a stored backplane identification. The stored backplane identification is the ID of the last backplane that was coupled to the computer. If the stored ID does not match the ID from the backplane, the computer transmits a command to the network indicating that the computer has been moved to a new physical location. A server can receive the command and automatically re-configure the network so that a network address and/or telephone number associated with the computer is routed to the backplane.

The computer may also transmit a client identification that is used by the server to determine whether the computer is authorized for usage. The server may send a command to inhibit operation of the computer, and/or generate an alarm, if there is no authorization. When unplugged from the backplane the computer may wirelessly emit an RF id if the computer was not properly shutdown. The RF id may be received by the system and activate an alarm to signify that someone is attempting to remove the computer after an improper shutdown sequence.

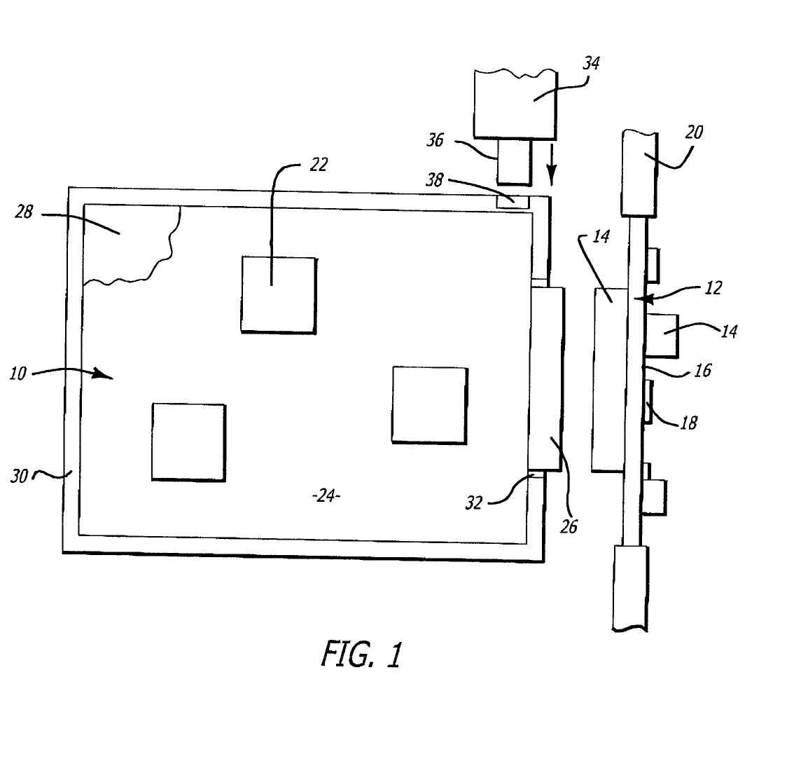

Referring to the drawings more particularly by reference numbers, FIG. 1 shows a computer 10 and a backplane 12 of a system of the present invention. The backplane 12 may include a plurality of electrical connectors 14 mounted to a printed circuit board 16. Each electrical connector 14 may have a keying feature to insure that only the proper corresponding device can be mated with the connector 14. The printed circuit board 16 may support a plurality of integrated circuits 18 that are coupled to the connectors 14. The backplane 12 may be mounted to a structure 20 such as a wall.

The computer 10 may include a plurality of integrated circuits 22 mounted to a printed circuit board 24. The integrated circuits 22 may be connected to an electrical connector 26 that is attached to the board 24. The connector 26 may mate with one of the connectors 14 of the backplane 12. The printed circuit board 24 may also be connected to a hard disk drive 28. The hard disk drive 28 is coupled to the integrated circuits 22. The printed circuit board 24, integrated circuits 22 and hard disk drive 28 may all be enclosed by an outer housing 30. The outer housing 30 may have an opening 32 to allow the connectors 26 and 14 to mate.

The system 14 may include a mechanical lock 34 that is mounted to the structure 20. The lock 34 can be actuated to secure the computer 10 to the backplane 12. By way of example, the lock 34 may be a solenoid actuated plunger 36 that moves into a corresponding slot 38 the housing 30. The plunger 36 can be moved out of the slot 38 to allow the computer 10 to be pulled out of the backplane 12.

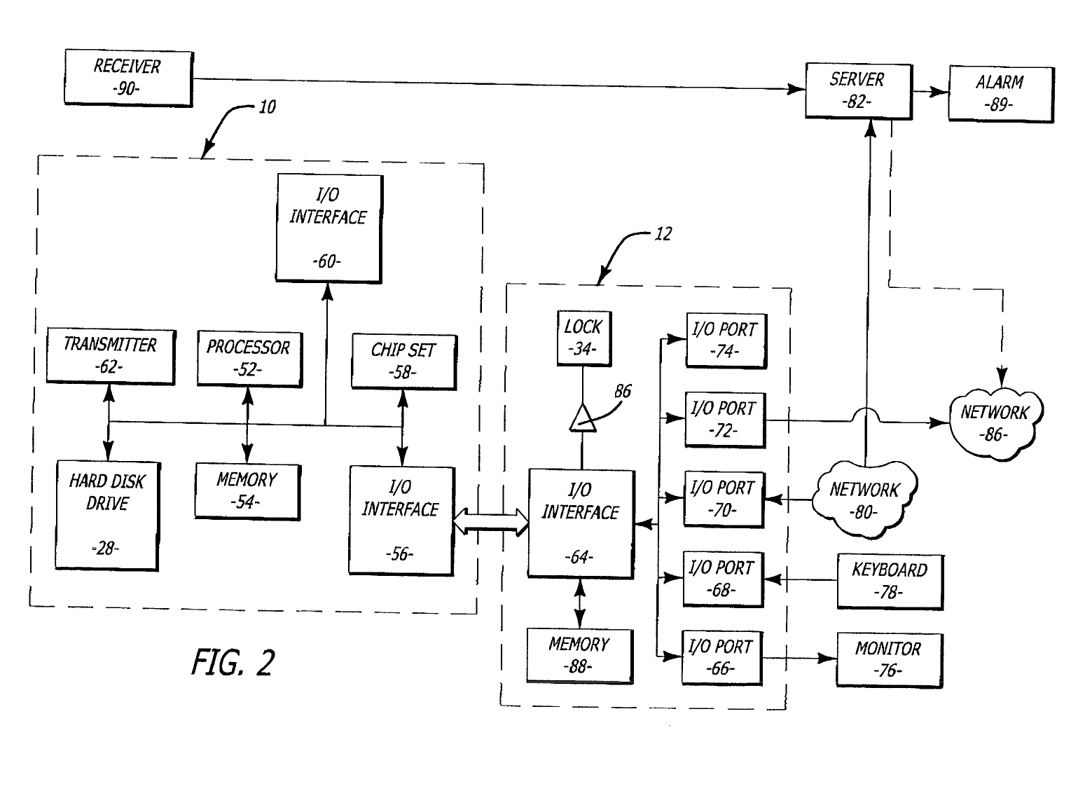

FIG. 2 shows a schematic of a system 50 that includes the computer 10 and the backplane 12. The computer 10 may include a microprocessor 52 that is coupled to one or more memory devices 54, an input/output (I/O) interface 56 and the hard disk drive 28. The memory devices 54 may include volatile and/or non-volatile memory such as dynamic random access memory (DRAM), static random access memory (SRAM) and read only memory (ROM).

The I/O interface 56 is connected to the connector 26. The microprocessor 52 may be connected to a graphics controller that is integrated with other functions such as bus management in an integrated circuit commonly referred to as a chip set 58. The microprocessor 52 may also be connected to a secondary I/O interface 60. The secondary I/O interface 60 can be coupled to an external device such as additional memory (not shown).

The computer 10 may also have a transmitter 62 that can wirelessly transmit signals. By way of example, the transmitter 62 can transmit signals at radio frequency (RF). The transmitter 62 may be coupled to a non-volatile memory device that contains an RF id. If the computer 10 is not properly shut down and detached from the backplane 12, the transmitter 62 may then automatically transmit the RF id on a continuous or periodic basis. For example, the computer 10 may require a password or biometric entry to properly shut down and remove the computer 10. If the passwork/biometric is not properly entered and the operator pulls the computer 10 out of the backplane 12 the processor 52 may cause the transmitter 62 to emit the RF id. The computer 10 would have a battery (not shown) to provide power to the transmitter 62.

The backplane 12 may have an I/O interface 64 that is connected to I/O ports 66, 68, 70, 72 and 74. Each I/O port 66, 68, 70, 72 and 74 is connected to a corresponding electrical connector. The I/O interface 64 is also connected to a connector that can be mated to the computer 10.

The I/O ports 66, 68, 70, 72 and 74 can be connected to external devices that communicate with the backplane 12 using different signals and different protocols. The interface 64 may contain the protocols required to transmit information through the ports 66, 68, 70, 72 and 74. The ports 66, 68, 70, 72 and 74 may have circuits to drive the signals to interface with the physical layer of the external device.

By way of example, I/O port 66, may be connected to a monitor 76. The I/O interface 64 and port 66 can be configured to transmit signals from the computer 10 in accordance with signal levels, protocols required to drive the monitor 76. The I/O interface 64 may include a hot plug firmware routine that determines the protocol, signals required to drive the monitor 76 through a series of handshake signals transmitted between the devices 64 and 76.

I/O port 68 may be connected to a keyboard 78. The interface 64 and port 68 may be configured to provide protocols and signal levels which allow information to be transmitted from the keyboard 78 to the computer 10.

I/O port 70 may be connected to a network 80. The network 80 may be connected to a server 82. By way of example, the I/O port 70 may include integrated circuits that transmit signals in accordance with an Ethernet standard.

Information may be transmitted through the network 80 in accordance with a Transmission Control Protocol/Internet Protocol (TCP/IP). I/O port 72 may be connected to a telephone network 86. The telephone network 86 may be a plain old telephone system (POTS), a public telephone network (PTN), Integrated Service Data Network (ISDN), Digital Subscriber Line (DSL) or another other phone service. The interface 64 and port 72 may transmit information in accordance with the signal levels, frequencies, protocols, etc. of the telephone network.

I/O port 74 may be an open port for additional devices. For example, port 74 may support USB protocol. The backplane 12 may have additional ports that support other post, present and future protocols and physical layer specifications. The I/O interface 64 may also be connected to the lock 34 by lock driver 86.

The backplane 12 may have a memory device 88 that is connected to the I/O interface 64. The memory device 88 may be non-volatile memory such as an EEPROM. The memory device 88 may include a backplane identification. The backplane identification is unique to the backplane 12.

By way of example, there are typically a plurality of backplanes 12 connected to the networks 80 and 86. Each backplane 12 will have a different backplane identification. The backplane identification may be a series of alphanumeric characters. The backplane identification may also be encrypted.

The computer 10 may store a unique client identification. The client identification may include personal information of the computer end user. The personal information may include a network address and telephone number for the computer. The client identification may be encrypted or otherwise encoded. The client identification may be stored in at least one hidden sector of the hard disk drive, to prevent unauthorized access to the client ID.

The server 82 may also be connected to the telephone network 86, an alarm 89 and a receiver 90. The receiver 90 can be adapted to receive the signal emitted by the transmitter 62 of the computer 10. The alarm 89 may include an audio and/or visual indicator such as a speaker and LCD display, respectively.

The network 80 may include routers and hubs (not shown) that route information to the computer 10 in accordance with a network address. By way of example, the network address may be an Internet Protocol (IP) address. Likewise, the telephone network 84 may switch information to the computer 10 in accordance with a telephone number.

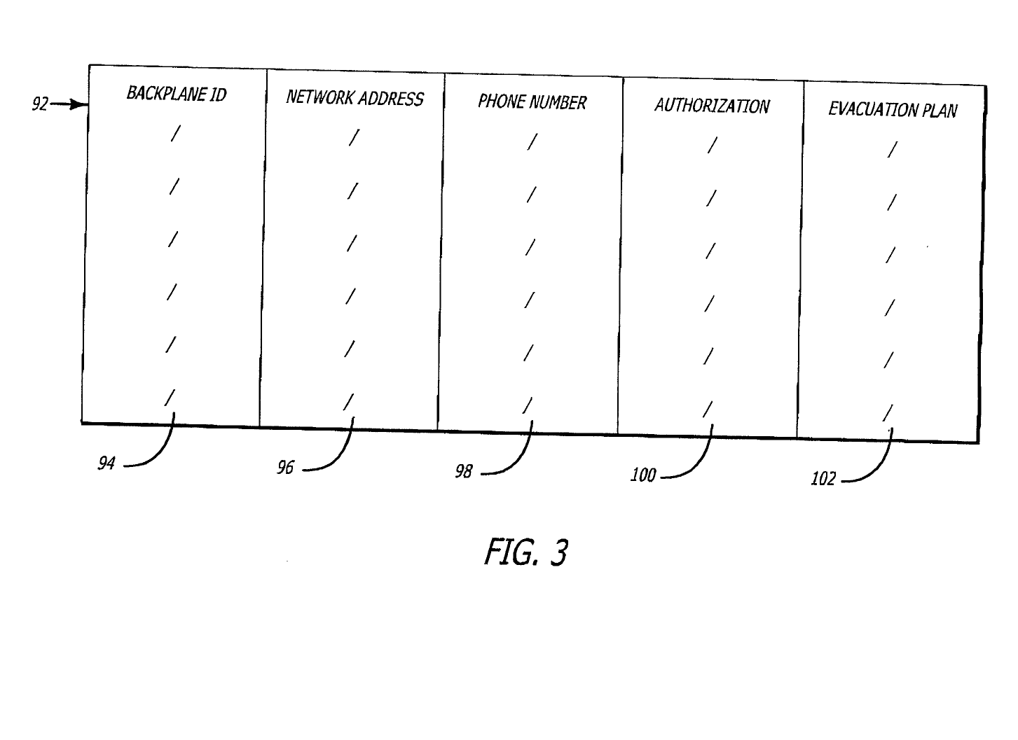

As shown in FIG. 3, the server 82 may include a relational database 92. The database 92 may have a backplane identification field 94, a network address field 96, a phone number field 98, an authorization field 100 and an evacuation plan field 102. The database 92 correlates each backplane identification and corresponding physical cable numbers of both the network connection and phone connection of the corresponding backplane, with a network address, phone number and evacuation plan.

The server 82 may operate in accordance with a software routine that accepts a command from the computer 10 and reconfigures the networks 80 and 84 in accordance with the command. For example, the command may include the client identification and an instruction to re-configure the networks 80 and 84. The server 82 will then correlate the backplane identification and evacuation plan with the network address and phone number associated with the client identification. The server may include a look-up table that associates the client identification with a network address and phone number. The server 82 can then vary the network relational database to correlate the address and phone number of the client ID with the backplane that is mated with the computer. Once the networks 82 and 84 are re-configured all information associated with the address and phone number of the computer 10 will be routed to the appropriate backplane. The computer ID automatically reconfigures the network(s) by transmitting a command. There is no requirement to manually re-configure the system.

The server 82 may also have a software routine that compares the client identification with an authorized client identification and activates the alarm if the identifications do not match. The server 82 may also send a command to the backplane 12 to drive the lock into a locked position so that the end user cannot unplug the computer 10 from the backplane. The server may also inhibit operation of the computer. For example, the server may send a command(s) to turn off the computer 10, or prevent communication through the backplane 12.

The transmitter 62 may transmit the RF id if the computer 10 is improperly detached from the backplane 12. The RF id signal is received by the receiver 90. The server 82 may have a software routine that drives the alarm 88 and records the alarm event when the receiver 90 senses the RF id.

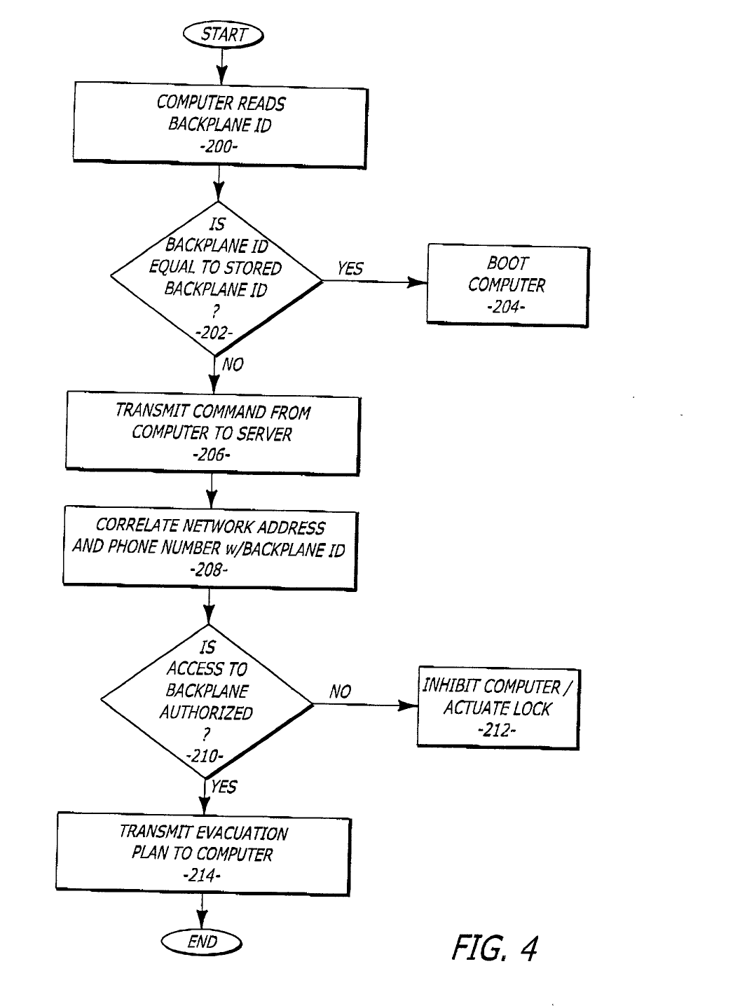

The microprocessor 52 may operate in accordance with a software routine. The software routine may be performed in accordance with instructions and data stored within memory 54 and/or the hard disk drive 28. FIG. 4 describes an operation of the system by software routines performed by the computer 10 and the server 82.

The end user initially plugs the computer 10 into the backplane 12. The computer 10 then reads the backplane identification from the memory device 88 in process block 200. The backplane ID can be read during an initialization routine of the computer 40, wherein the processor 52 request data from the appropriate address(es) of the backplane memory 76. In decision block 202 the computer 10 compares the backplane identification transmitted from the backplane with a stored backplane identification The stored backplane identification is the backplane ID for the backplane that was last coupled to the computer 10. If the identifications match, a boot up routine is run so that the computer 10 can be operated in process block 204. Matching IDs signifies that the computer 10 has not been moved to a different backplane.

If the identifications do not match, the computer transmits a command to the server in block 206. The command may include the client identification. The client ID may be retrieved from the hidden sector(s) of the hard disk drive 28.

The command may be routed to the server in accordance with a server network address entered into the computer through a configuration program. Alternatively, the server may download the network address when the computer ID is plugged into the backplane 12. The backplane 12 may send a signal to prompt a download of the server network address when the connectors 14 and 26 are mated. The server then correlates the client identification information such as network address and phone number with the backplane identification in block 208. All information addressed to the network address and/or phone number will then be routed to the corresponding backplane associated with the client identification.

The server may compare the client identification with an authorized client identification in decision block 210. If authorization is not granted the server may transmit a command(s) to the backplane to inhibit operation of the computer and/or engage the lock in process block 212. If authorization is granted the server may then transmit a evacuation plan 214 to the computer 10. The evacuation plan may include diagrams, etc. that show the end user an evacuation route from the facility. The evacuation plan is unique to the backplane, such that the evacuation route is specifically directed to the physical location of the backplane. The computer 10 can be booted subsequent to the transmission of the command in step 206.

The present invention thus provides a system and method to automatically re-configure a network when a computer is plugged into a backplane.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

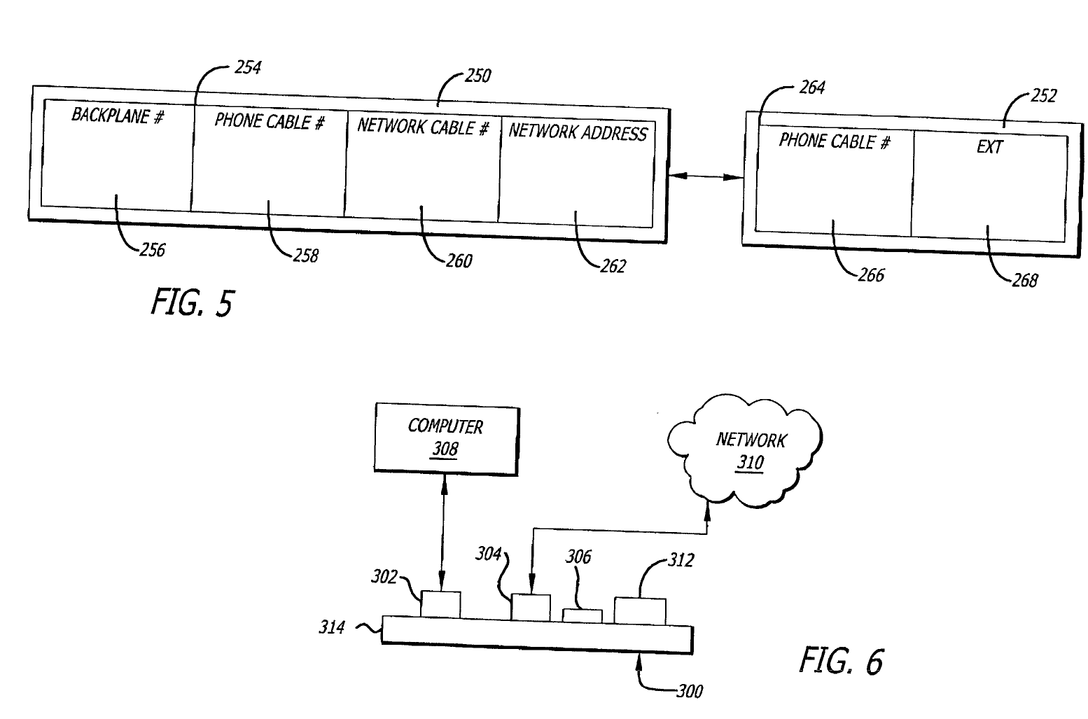

For example FIG. 5 shows an alternate embodiment of a system with a server 250 connected to a phone switch 252. The server 250 includes a relational database 254 that has a backplane identification field 256 that is correlated with a phone cable number field 258, a network cable number field 260 and a network address field 262. The cable numbers correspond to the physical cables that are attached to the backplane with the corresponding backplane identification.

The phone switch 252 may have a relational database 264 that has a phone cable number field 266 and a phone number field 268. When the computer 10 is plugged into a different backplane both relational databases 254 and 264 are updated to correlate the network address and phone number of the computer with the physical cables attached to the backplane. This embodiment is similar to the embodiment shown in FIG. 3, except that the correlation between the phone number and cable number is provided in the phone switch 252. Conventional phone switches already have such correlations. This embodiment thus provides a system that can be readily integrated into existing phone systems. The servers 250 and 252 can be linked by a network line. By way of example, the network line may operate in accordance with an Ethernet protocol. Connecting servers 250 and 252 over a network line may allow voice over IP service for the system. Incoming phone calls can be routed to the backplane through the servers 250 and 252.

FIG. 6 shows another embodiment of a backplane 300 that has a pair of network connectors 302 and 304, and one or more integrated circuits 306. Connector 302 can be coupled to a computer 308. Connector 304 can be coupled to a network 310. The integrated circuits 306 may include a backplane identification, hardware and firmware that allow the computer 308 to be connected to the network 310 in accordance with the teachings of the embodiment shown in FIGS. 1-4. The backplane 300 may be packaged as a consumer product that can be purchased and connected to an existing computer 308. The product may also include software that can be loaded into the computer 308 to operate the routine shown and discussed in the embodiments of FIGS. 1-4. The backplane 300 may have an additional power connector 312 to provide power for the integrated circuits 306. The connectors 302 can be plugged into the LAN connections of the computer 308 and network 310. The connectors 302, 304, 312 and integrated circuits 306 may be mounted to a single printed circuit board 314.

What is claimed is:

1. A computer system that can be coupled to a network, comprising:
a backplane that contains a unique identification; and,
a computer that can be plugged into said backplane and retrieve the backplane identification, said computer compares the backplane identification with a stored backplane identification stored in said computer, and transmits a command to the network if the backplane identification does not match the stored backplane identification.

2. The system of claim 1, wherein said computer has a network address and the command re-configures the network to route information associated with the network address to said computer.

3. The system of claim 2, wherein the network address is an internet address.

4. The system of claim 1, wherein said computer has a telephone number and the command re-configures the network to route information associated with the telephone number to said computer.

5. The system of claim 1, wherein the backplane identification is encrypted.

6. The system of claim 1, further comprising a mechanical lock that secures said computer to said backplane.

7. The system of claim 1, further comprising a monitor that is coupled to said backplane.

8. The system of claim 1, further comprising a keyboard that is coupled to said backplane.

9. The system of claim 1, wherein said backplane includes an input/output interface that is coupled to a plurality of input/output ports, said input/output ports each provide a communication path for information transmitted in an accordance with a different protocol.

10. The system of claim 1, wherein said computer communicates with said input/output interface to determine said input/output ports.

11. The system of claim 1, wherein the command includes a client identification.

12. The system of claim 1, wherein said computer includes a hard disk drive and a client identification is stored within at least one hidden sector of said hard disk drive.

13. A system, comprising:
a server;
a backplane that is coupled to said server and which contains a unique backplane identification; and,
a computer that can be plugged into said backplane and retrieve the backplane identification, said computer compares the backplane identification with a stored backplane identification stored in said computer, and transmits a command to said server if the backplane identification does not match the stored backplane identification.

14. The system of claim 13, wherein said server includes a relational database that correlates said backplane with a network address of said computer and the command re-configures the relational database to route information associated with the network address to said computer.

15. The system of claim 14, wherein the network address is an internet address.

16. The system of claim 13, wherein said server includes a relational database that correlates said backplane with a telephone number of said computer and the command re-configures the relational database to route information associated with a telephone number to said computer.

17. The system of claim 13, wherein the backplane identification is encrypted.

18. The system of claim 13, wherein the command includes a client identification.

19. The system of claim 13, wherein said computer includes a hard disk drive and a client identification is stored within at least one hidden sector of said hard disk drive.

20. The system of claim 18, wherein said server compares the client identification with an authorized client identification and inhibits operation of said computer if the client identification does not match the authorized client identification.

21. The system of claim 20, wherein said server generates an alarm in response to receiving a RF id from said computer.

22. The system of claim 13, wherein said server transmits an evacuation plan to said computer when said computer is coupled into said backplane.

23. A system, comprising:
a server that has a relational database that correlates a network address to a backplane address;
a backplane that is coupled to said server and contains a unique backplane identification; and,
a computer that can be coupled into said backplane, said computer has a client identification and a computer network address, said computer transmits the client identification to said server so that the computer network address is correlated with the backplane identification.

24. The system of claim 23, wherein the network address is an internet address.

25. The system of claim 23, wherein said computer includes a hard disk drive and the client identification is stored within at least one hidden sector of said hard disk drive.

26. The system of claim 23, wherein the relational database correlates the backplane identification with a telephone number of said computer and the transmitted client identification causes the backplane identification to be correlated with the telephone number.

27. The system of claim 23, wherein said server compares the client identification with an authorized client identification and inhibits operation of said computer if the client identification does not match the authorized client identification.

28. The system of claim 27, wherein said server generates an alarm in response to receiving a RF id from said computer.

29. The system of claim 23, wherein said server transmits an evacuation plan to said computer when said computer is coupled to said backplane.

30. A system, comprising:
a server that has a relational database that correlates a telephone number to a backplane address;
a backplane that is coupled to said server and contains a unique backplane identification; and,
a computer that can be coupled to said backplane, said computer has a client identification and a telephone number, said computer transmits the client identification to said server so that the telephone number is correlated with the backplane identification.

31. The system of claim 30, wherein said computer includes a hard disk drive and the client identification is stored within at least one hidden sector of said hard disk drive.

32. The system of claim 30, wherein said server compares the client identification with an authorized client identification and inhibits operation of said computer if the client identification does not match the authorized client identification.

33. The system of claim 32, wherein said server generates an alarm if the client identification does not match the authorized client identification.

34. The system of claim 30, wherein said server transmits an evacuation plan to said computer when said computer is coupled into said backplane.

35. A system, comprising:
a backplane;
a computer that can be coupled into said backplane, said computer wirelessly emits a RF id when decoupled from said backplane;
a receiver that receives the RF id;
an alarm that is coupled to said receiver and is activated in response to the RF id.

36. The system of claim 35, wherein said backplane contains a unique backplane identification, said computer compares the backplane identification with a stored backplane identification stored in said computer, and transmits a command to said server if the backplane identification does not match the stored backplane identification.

37. The system of claim 36, further comprising a server coupled to said backplane, said server includes a relational database that correlates said backplane with a network address of said computer and the command re-configures the relational database to route information associated with a network address to said computer.

38. The system of claim 37, wherein the network address is an internet address.

39. The system of claim 36, further comprising a server that is coupled to said backplane, said server includes a relational database that correlates said backplane with a telephone number of said computer and the command re-configures the relational database to route information associated with a telephone number to said computer.

40. The system of claim 36, wherein the backplane identification is encrypted.

41. The system of claim 36, wherein the command includes a client identification.

42. The system of claim 41, wherein said computer includes a hard disk drive and the client identification may be stored within at least one hidden sector of said hard disk drive.

43. The system of claim 42, further comprising a server that is coupled to said backplane, said server compares the client identification with an authorized client identification and inhibits operation of said computer if the client identification does not match the authorized client identification.

44. The system of claim 43, wherein said server generates an alarm if the client identification does not match the authorized client identification.

45. The system of claim 36, wherein said server transmits an evacuation plan to said computer when said computer is coupled to said backplane.

46. A system, comprising:
a backplane that is coupled to said server and has a unique backplane identification;
a computer that can be coupled into said backplane; and,
a server that is coupled to said backplane and can transmit evacuation information to said computer said evacuation information being correlated with the backplane identification.

47. The system of claim 46, wherein said backplane contains a unique backplane identification, said computer compares the backplane identification with a stored backplane identification stored in said computer, and transmits a command to a server if the backplane identification does not match the stored backplane identification.

48. The system of claim 47, wherein said server includes a relational database that correlates said backplane with a network address of said computer and the command re-configures the relational database to route information associated with the network address to said computer.

49. The system of claim 48, wherein the network address is an internet address.

50. The system of claim 47, wherein said server includes a relational database that correlates said backplane with a telephone number of said computer and the command re-configures the relational database to route information associated with the telephone number to said computer.

51. The system of claim 47, wherein the backplane identification is encrypted.

52. The system of claim 47, wherein the command includes a client identification.

53. The system of claim 52, wherein said computer includes a hard disk drive and the client identification is stored within at least one hidden sector of said hard disk drive.

54. The system of claim 52, wherein said server compares the client identification with an authorized client identification and inhibits operation of said computer if the client identification does not match the authorized client identification.

55. The system of claim 54, wherein said server generates an alarm in response to receiving a RF id from said computer.

56. A method for operating a computer system, comprising:
plugging a computer into a backplane;
transmitting a backplane identification from the backplane to the computer;
comparing the backplane identification with a stored backplane identification; and,
transmitting a command to a network if the backplane identification does not match the stored backplane identification.

57. The method of claim 56, wherein the command reconfigures a relational database so that the backplane identification is correlated with a network address of the computer.

58. The method of claim 56, wherein the command re-configures a relational database so that the backplane identification is correlated with a telephone number of the computer.

59. The method of claim 56, further comprising comparing a client identification transmitted with the command with an authorized client identification and inhibiting operation of the computer if the client identification does not match the authorized client identification.

60. The method of claim 59, further comprising activating an alarm if the client identification does not match the authorized client identification.

61. A method for operating a computer system, comprising:
plugging a computer into a backplane that has a backplane identification;
transmitting a client identification from the computer to a server; and,
correlating the client identification with the backplane identification.

62. The method of claim 61, wherein the backplane identification is correlated with a network address of the computer.

63. The method of claim 61, wherein the backplane identification is correlated with a telephone number of the computer.

64. The method of claim 61, further comprising comparing the client identification with an authorized client identification and inhibiting operation of the computer if the client identification does not match the authorized client identification.

65. The method of claim 64, further comprising activating an alarm if the client identification does not match the authorized client identification.

66. A method for operating a computer system, comprising:
unplugging a computer from a backplane;
transmitting a client identification from the computer to a wireless detector;
comparing the client identification with an authorized client identification; and,
activating an alarm if the client identification does not match the authorized client identification.

67. A computer system that can be plugged into a backplane which is coupled to network, wherein the backplane has a unique backplane identification, comprising:
a memory device that contains a stored backplane identification number; and,
a processor that reads the backplane identification from the backplane, compares the backplane identification with the stored backplane identification, and transmits a command to the network if the backplane identification does not match the stored backplane identification.

68. The computer of claim 67, wherein said memory device includes a hard disk drive.

69. The computer of claim 68, wherein the command in includes a client identification stored in at least one hidden sector of said hard disk drive.

70. A backplane that can be coupled to a computer and a network, comprising:
a printed circuit board;
a first network connector that can be coupled to the computer;
a second network connector that can be coupled to the network; and,
an integrated circuit that is attached to said printed circuit board and contains a backplane identification.

71. The backplane of claim 70, further comprising a power supply connector that is attached to said printed circuit board.
